(19) United States
(12) Patent Application Publication
(10) Pub. No.: US 2006/0274753 A1
(43) Pub. Date: Dec. 7, 2006

(54) Method and system for maintaining persistent unique identifiers for devices in a network

(75) Inventors: Hoyong Park, San Jose, CA (US); Praveen Kumar, San Jose, CA (US); Alan Messer, Los Gatos, CA (US); Victor Zhu, Milpitas, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/147,637

(22) Filed: Jun. 7, 2005

(51) Int. Cl. H04L 12/28

(52) U.S. Cl. 370/392; 370/401

(57) ABSTRACT

A method of maintaining persistent unique identifiers for devices interconnected in a network. Information is obtained from a device and a fingerprint generated from that information. It is then determined if the fingerprint is previously associated with an identifier in the network. If the fingerprint is not previously associated with an identifier in the network, then a new identifier associated with the fingerprint is generated, and the fingerprint and the associated new identifier is stored in a memory, wherein the new identifier forms a persistent unique identifier (PUID) for that device. Otherwise, if the fingerprint is not previously associated with an identifier in the network, then the associated identifier stored in the memory is used as the persistent unique identifier (PUID) for that device.

### FIELD OF THE INVENTION

The present invention relates to device identification, and in particular device identification in networks.

### BACKGROUND OF THE INVENTION

Many device architecture standards for networks use a two device type model: controller devices (i.e., controller) and controlled devices. In this model, controllers act as masters for the controlled devices. Controllers keep track of the state of controlled devices in order to maintain connections and operations to the controlled devices. Within home network environments, controlled devices may be removed from the network for different reasons such as software defects, power failure, user intervention, etc. In such cases, controllers may require use of the same state for the controlled devices to continue the previous operation without interruption, if a controlled device is removed from the home network and later reconnected to the home network. As such, a persistent unique identifier for devices is necessary to identify the device and to use the same state.

Conventionally, Universal Plug and Play (UPnP) uses two identifications: (1) Universal Resource Locator (URL) to the UPnP description of the root device contains a literal IP address and port number, and (2) Unique Device Name (UDN) is a universally-unique identifier for the device in the UPnP description. However, the UPnP device architecture specification specifies that UDN are based on MAC address and time, and so is not constant over time. URLs can also be changed when devices reboot as new IP address or different port numbers can be assigned.

Home Audio Visual Interoperability architecture (HAVi) uses a globally unique identifier (GUID) to identify devices independent of a firewire bus reset, as firewire identifiers may change after a firewire bus reset. However, the GUID for a device is allowed to change over time if there is no persistence in the device. Further, some device architectures do not define an identifier for devices. In such cases, it becomes the controllers' responsibility to identify devices.

The situation becomes more complicated when different device stacks and protocols are mixed in a network and a controller must use mixed devices. Within such an environment, controllers need to identify devices from different device architectures. In addition, many controllers can co-exist in the network.

There is, therefore, a need for a method and system for maintaining a persistent unique identifier for devices. There is also a need for such a method and system to allow controllers to use the same identifier for the same device, such that by sharing the identifiers, operations from one controller can easily transferred to other controllers.

### BRIEF SUMMARY OF THE INVENTION

The present invention addresses the above problems. In one embodiment, the present invention provides a method and system of automatically maintaining persistent unique identifiers for networked devices that may be removed from the network, and later reintroduced into the network.

An embodiment of a method of maintaining persistent unique identifiers for devices interconnected in a network according to the present invention comprises the step of: obtaining information from a device; generating a fingerprint from that information; determining if the fingerprint is previously associated with an identifier in the network; if the fingerprint is not previously associated with an identifier in the network, then: (a) generating a new identifier associated with the fingerprint, and (b) storing the fingerprint and the associated new identifier in a memory, wherein the new identifier forms a persistent unique identifier (PUID) for that device; otherwise, if the fingerprint was previously associated with an identifier in the network, then utilizing the associated identifier stored in the memory as the persistent unique identifier (PUID) for that device.

The obtained information from device can include device information. Determining if the fingerprint is previously associated with an identifier in the network can further include the steps of searching the stored fingerprints and associated identifiers in the memory. The step of generating a new identifier associated with the fingerprint can further include the steps of mapping the fingerprint to a unique identifier. In addition, the step of generating a fingerprint can further includes the steps of generating a message digest from the obtained information.

The step of storing the new identifier can further include the steps of storing the new identifier associated with the message digest in a message digest table in a controller's memory or a persistent store. Further, the step of generating a new identifier associated with the message digest can include the steps of mapping the message digest to a unique identifier. The method can further include the steps of broadcasting the new PUID to device controllers in the network, in order to maintain consistency of the PUIDs for said devices among the device controllers in the network.

In another embodiment the present invention provides a system for maintaining persistent unique identifiers for devices interconnected in a network, comprising: an identification apparatus that generates a fingerprint from information obtained from a device; a mapper that determines if the fingerprint is previously associated with an identifier in the network; a generator that generates a new identifier; such that: if the fingerprint is not previously associated with an identifier in the network, then the generator generates a new identifier associated with the fingerprint, and the mapper stores the fingerprint and the associated new identifier in a memory, wherein the new identifier forms a persistent unique identifier (PUID) for that device; otherwise, if the fingerprint is previously associated with an identifier in the network, then the mapper utilizes the associated identifier stored in the memory as the persistent unique identifier (PUID) for that device.

In another embodiment the present invention provides a network comprising: a plurality of devices interconnected with a controller that controls one or more said devices; and a system connected to the network, wherein the system allows the controller to maintain persistent unique identifiers for one or more of the devices, the system comprising: an identification apparatus that generates a fingerprint from information obtained from a device; a mapper that determines if the fingerprint is previously associated with an identifier in the network; a generator that generates a new identifier; such that: if the fingerprint is not previously associated with an identifier in the network, then the generator generates a new identifier associated with the fingerprint, and the mapper stores the fingerprint and the associated new identifier in a memory, wherein the new identifier forms a persistent unique identifier (PUID) for that device; and if the fingerprint was previously associated with an identifier in the network, then the mapper utilizes the associated identifier stored in the memory as the persistent unique identifier (PUID) for that device.

According to the present invention, by using persistent unique identifiers, controllers can identify the same controller device and use their previous state to refer operations to the same controller device without reconfiguration. This allows for quick fault recovery. Such a method and system provides a unique identifier even if the device architecture does not define an identifier.

Further, by using persistent unique identifiers, controllers can share the identifiers and transfer operations to other controllers easily. By transferring operations from faulty controllers to other controllers, the network can be more reliable. In addition, users can move to other locations and continue operation by transferring operations from a control point in the previous location to a control point in the new location within the network. In another embodiment, the control point uses a device to be identified, to store the globally unique persistent ID back into the device. Then, the control point can retrieve that ID from the device when the control point encounters that device again.

Other embodiments, features and advantages of the present invention will be apparent from the following specification taken in conjunction with the following drawings.

### BRIEF DESCRIPTION OF THE DRAWINGS

FIG. 1 shows an example functional block diagram of a network according to an embodiment of the present invention;

FIG. 2 shows an example functional block diagram of a system for maintaining persistent unique identifiers for devices in a network according to another embodiment of the present invention; and

FIG. 3 shows a flowchart of an example method for maintaining persistent unique identifiers for devices in a network according to another embodiment of the present invention.

### DETAILED DESCRIPTION OF THE INVENTION

In one embodiment the present invention provides a method and system of automatically maintaining persistent unique identifiers for networked devices that may be removed from the network, and later reintroduced into the network.

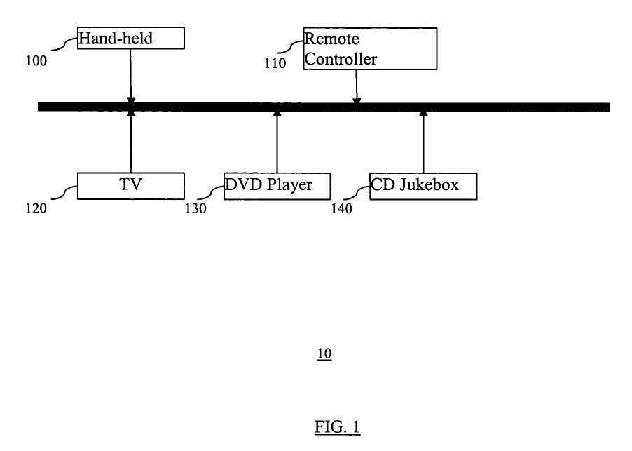

FIG. 1 shows an example functional block diagram of a network 10 (e.g., home network) in which an embodiment of the present invention is implemented. In this example, a hand-held device 100, a remote controller 110, home electronics devices, such as a DVD player 120, a TV 130, and a CD jukebox 140, are connected to the home network 10. The hand-held device 100 and the remote controller 110 are control points (i.e., controllers) with which the home electronics devices (i.e., controlled devices) are controlled.

The controllers 100 and 110 discover the controlled devices 120, 130 and 140 in the network 10, and retrieve device descriptions from the controlled devices 120, 130 and 140. Using the device descriptions, the controller 100 and 110 generate unique and persistent device identifiers (PUIDs) for controlling the controlled devices 120, 130 and 140.

In one example, the hand-held device 100 uses a unique and persistent identifier for controlling the CD jukebox 140 to play a list of tracks for a user by showing the current track information on a display of the hand-held device 100. The hand-held device 100 implements a method of maintaining a persistent unique identifier for each controlled device, with which the hand-held device 100 can keep track of the operation of the controlled devices.

In one operation scenario, if the CD jukebox 140 is disconnected from the network 10 (e.g., due to temporary power outage), and later reconnected to the network 10, the hand-held device 100 uniquely re-identifies the CD jukebox 140 (i.e., generates the same unique and persistent identifier) in order to continue previous session of playing a list of tracks. Without this feature according to the present invention, a user needs to re-invoke commands to the hand-held device 100 to play the list of tracks.

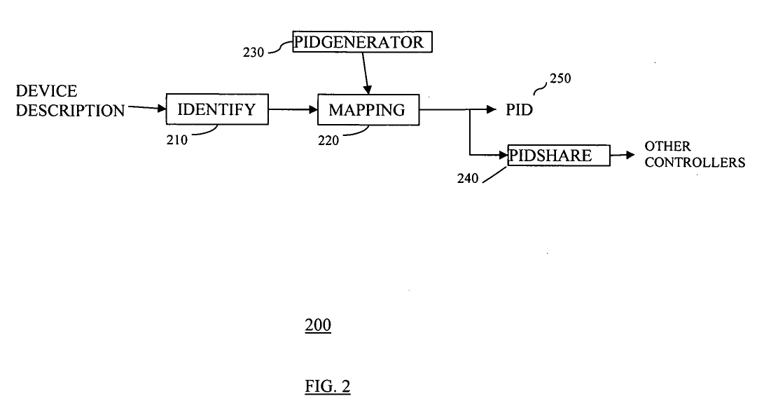

FIG. 2 shows an example function block diagram of the architecture of a system 200 according to the present invention which generates and maintains a persistent and unique identifier (PUID) for each controlled device. The system 200 can be implemented within each controller. In this example, the system includes an identifier block 210, a mapper 220, a PUID generator 230, and a PUIDshare block 240.

In this example, the identifier block 210 identifies the same controlled device even after the device restarts. The identifier block 210 uses a device description from the device to identify the device (examples of device description include hash of the device name, device API, device MAC address, device service description, device configuration, device serial number, etc.). The identifier block 210 utilizes the device and service descriptions rather than a simple identifier from that device, because the simple identifier from a device may change through restarts. In addition, using the device description provides a more robust identification process.

As those skilled in the art will appreciate, other information in place of, or in addition to, the device description may be utilized which allows the system to generate a persistent and unique identifier for each device according to the present invention.

The identifier block 210 generates a fingerprint or message digest from the device description. Techniques such as MD5 message-digest algorithm or Cyclic Redundancy Code (CRC), can be used to generate message digests. Message digests are usually 128-bit fixed numbers and are generated from a message of arbitrary length. Generally, it is computationally infeasible to produce two messages having the same message digest, or to produce any message having a pre-specified target message digest. The idea is that a variety of information is gained and used to generate the ID. Therefore, the mapper 220 does not store information, but instead generates the PUID from the information using a hash function.

The mapper 220 uses the message digest generated by the identifier block 210 to determine if the device is already known to the controller associated with the system. To do so, the mapper 220 searches an internal table (e.g., message digest table) that maintains mapping from a message digest to a persistent identifier for the message digest. The mapper 220 can use a known technique for mapping an entity to another entity such as a hash table, wherein a hash table is a dictionary in which keys are mapped to a position by a hash function. In one embodiment of the present invention, the key for the dictionary is the message digest and the value for the dictionary is the persistent identifier.

If the message digest for a device is found in the internal tables of the mapper 220, the associated PUID 250 is used by the controller. If the message digest for the device is not found in the internal tables of the mapper 220, then the generator 230 generates a unique identifier. A globally unique identifier (GUID) is most widely used for generating a unique identifier. As GUID algorithms require a real time clock (RTC) which may not be available, simple random numbers can replace the clock value. A new PUID 250 is generated by the mapper 220 and is associated with the message digest. The new PUID 250 is also stored in the internal tables of the mapper 220.

In another embodiment, a table is not used, rather for certain classes of devices, specific device-related information is used in a hash function to generate a globally unique PUID. As such, the finger print is generated from the message digest and the identifier block and used as the PUID. An example of using a device description to generate a PUID includes the steps of: read a UPnP description, checking to see if a PUID is already there and if not, then extract APIs from that description, extract device name from that description, extract manufacturer name and serial number from that description, hash over the extracted information resulting in a 128-bit number, and using that number as a PUID. An alternative embodiment is that the hash itself is used as the ID, whereby there is no need for a lookup table. Hashes are usually 128 bit numbers, so they can easily be used as the ID itself.

The PUIDShare block 240 broadcasts the new PUID 250 to other controllers in the network. The PUIDShare 240 is responsible for maintaining the consistency of the persistent identifier PUID for the devices among the controllers. It is possible for other controllers to generate new PUIDs simultaneously and to broadcast to other controllers. The PUIDShare 240 in each controller implements a typical distributed updating, to pick a unique identifier for use in the network. In another example, a replication technique can be used for PUIDShare 240 to be more efficient by reducing network traffic.

In an alternative embodiment, the identifier block 210 implements rule-based decision logic instead of device descriptions from the devices. Rule-based decision logic could be used for identifying the device description fields to determine similar devices. In one example, a rule uses a serial number or a product UPC to identify a device. As those skilled in the art will appreciate, other example rules are possible.

When a controller is turned on and connects to the network, the controller prompts the mapper to establish the above-mentioned mapping for the controlled devices in the network. Using a persistent storage to store the persistent identifiers maintained by the mapper 220, the controller can avoid re-establishing the mapping and provide consistency to the user.

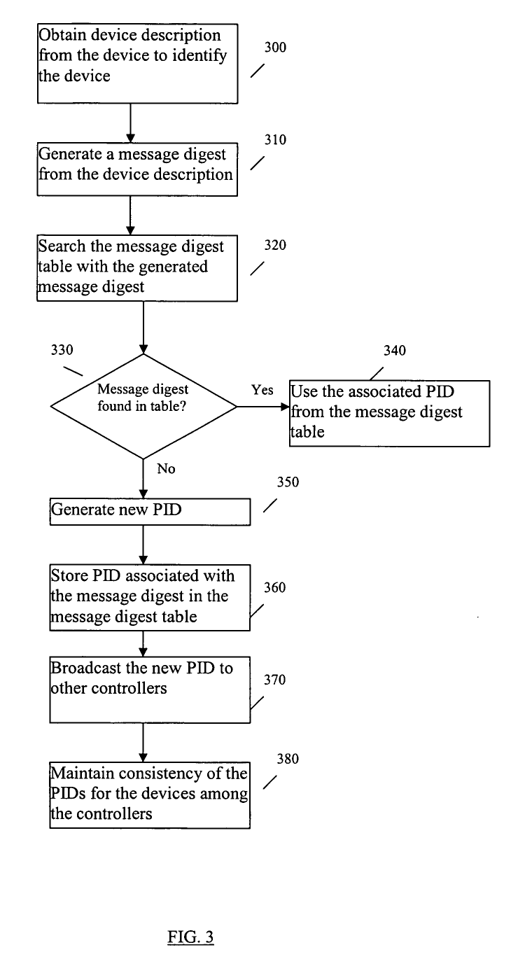

FIG. 3 shows an example flowchart of the steps of generating and maintaining a unique and persistent device identifier according to another embodiment of the present invention. The steps can be implemented as an independent system that is connected to the network 10, or in each controller in FIG. 1. In the flowchart of FIG. 3, an example operation within a controller is described wherein the controller identifies a device initially or after re-connected of the device to the network. As such, the controller performs steps including the following:

Obtain device description from the device to identify the device (step 300).

Generate a fingerprint or message digest from the device description (step 310).

Search the message digest table with the generated message digest to determine if the device is already known to the controller (step 320).

Is the generated message digest found in the message digest table (step 330).

If the message digest for the device is found in the message digest table, the associated PUID in the message digest table is accessed and used by the controller to identify the device (step 340).

If the message digest for the device is not found in the message digest table, generate a new PUID as described above (step 350).

Store new PUID in the message digest table (step 360).

Broadcast the new PUID to other controllers in the network (step 370).

Maintain consistency of the PUIDs for the devices among the controllers (step 380).

By using persistent unique identifiers, controllers can identify the same controller device and use their previous state to refer operations to the same controller device without reconfiguration. This allows for quick fault recovery and, more importantly, consistency to the user. Such a method and system provides a unique identifier even if the device architecture does not define an identifier.

For example, if a user has a cell phone, and uses that cell phone to connect to the system to transfer content to the cell phone, when the user disconnects from the system and later returns and reconnects to the system using that same cell phone, using the PUID scheme according to the present invention the system recognizes that same cell phone again.

Further, by using persistent unique identifiers PUIDs, controllers can share the identifiers and transfer operations to other controllers easily. By transferring operations from faulty controllers to other controllers, the network can be more reliable. In addition, users can move to other locations and continue operation by transferring operations from a control point in the previous location to a control point in the new location within the network.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures in FIGS. 1 and 2, according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of maintaining persistent unique identifiers for devices interconnected in a network, comprising the steps of:
obtaining information from a device;
generating a fingerprint from that information;
determining if the fingerprint is previously associated with an identifier in the network;
if the fingerprint is not previously associated with an identifier in the network, then:
(a) generating a new identifier associated with the fingerprint, and
(b) storing the fingerprint and the associated new identifier in a memory, wherein the new identifier forms a persistent unique identifier (PUID) for that device;
if the fingerprint is previously associated with an identifier in the network, then utilizing the associated identifier stored in the memory as the persistent unique identifier (PUID) for that device.

2. The method of claim 1 wherein the step of obtaining information from the device further includes the steps of obtaining device information from the device.

3. The method of claim 1 wherein the determining if the fingerprint is previously associated with an identifier in the network further includes the steps of searching the stored fingerprints and associated identifiers in the memory.

4. The method of claim 1 wherein the step of generating a new identifier associated with the fingerprint further includes the steps of mapping the fingerprint to a unique identifier.

5. The method of claim 1 wherein the step of generating a fingerprint further includes the steps of generating a message digest from the obtained information.

6. The method of claim 5 wherein the step of storing the new identifier further includes the steps of storing the new identifier associated with the message digest in a message digest table in the memory.

7. The method of claim 5 wherein the step of generating a new identifier associated with the message digest further includes the steps of mapping the message digest to a unique identifier.

8. The method of claim 1 further including the steps of broadcasting the new PUID to device controllers in the network.

9. The method of claim 8 further including the steps of maintaining consistency of the PUIDs for said devices among the device controllers in the network.

10. A system for maintaining persistent unique identifiers for devices interconnected in a network, comprising:
an identification apparatus that generates a fingerprint from information obtained from a device;
a mapper that determines if the fingerprint is previously associated with an identifier in the network;
a generator that generates a new identifier;
such that:
if the fingerprint is not previously associated with an identifier in the network, then the generator generates a new identifier associated with the fingerprint, and the mapper stores the fingerprint and the associated new identifier in a memory of a device, wherein the new identifier forms a persistent unique identifier (PUID) for that device; and
if the fingerprint is previously associated with an identifier in the network, then the mapper utilizes the associated identifier stored in the memory as the persistent unique identifier (PUID) for that device.

11. The system of claim 10 wherein the information obtained from the device comprises device information.

12. The system of claim 10 wherein the mapper determines if the fingerprint is previously associated with an identifier in the network by searching the stored fingerprints and associated identifiers in the memory.

13. The system of claim 10 wherein the generator further maps the fingerprint to a unique identifier.

14. The system of claim 10 wherein the generator generates a fingerprint by generating a message digest from the obtained information.

15. The system of claim 14 wherein the mapper stores the new identifier associated with the message digest in a message digest table in the memory.

16. The system of claim 14 wherein the generator generates the new identifier associated with the message digest by mapping the message digest to a unique identifier.

17. The system of claim 10 further comprising a consistency checker that broadcasts the new PUID to device controllers in the network.

18. The system of claim 17 wherein the consistency checker maintains consistency of the PUIDs for said devices among the device controllers in the network.

19. A network comprising:
a plurality of devices interconnected with a controller that controls one or more said devices; and
a system connected to the network, wherein the system allows the controller to maintain persistent unique identifiers for one or more of the devices, the system comprising:
an identification apparatus that generates a fingerprint from information obtained from a device;
a mapper that determines if the fingerprint is previously associated with an identifier in the network;
a generator that generates a new identifier;
such that:
if the fingerprint is not previously associated with an identifier in the network, then the generator generates a new identifier associated with the fingerprint, and the mapper stores the fingerprint and the associated new identifier in a memory of a device, wherein the new identifier forms a persistent unique identifier (PUID) for that device; and
if the fingerprint is previously associated with an identifier in the network, then the mapper utilizes the associated identifier stored in the memory as the persistent unique identifier (PUID) for that device.

20. The network of claim 19 wherein the information obtained from the device comprises device information.

21. The network of claim 19 wherein the mapper determines if the fingerprint is previously associated with an identifier in the network by searching the stored fingerprints and associated identifiers in the memory.

22. The network of claim 19 wherein the generator further maps the fingerprint to a unique identifier.

23. The network of claim 19 wherein the generator generates a fingerprint by generating a message digest from the obtained information.

24. The network of claim 14 wherein the mapper stores the new identifier associated with the message digest in a message digest table in the memory.

25. The network of claim 14 wherein the generator generates the new identifier associated with the message digest by mapping the message digest to a unique identifier.

26. The network of claim 19 further comprising two or more controller for controlling said devices, wherein the system further includes a consistency checker that broadcasts the new PUID to the controllers in the network.

27. The network of claim 17 wherein the consistency checker maintains consistency of the PUIDs for said devices among the controllers in the network.
